(19) United States
(12) Patent Application Publication
(10) Pub. No.: US 2016/0221504 A1
(43) Pub. Date: Aug. 4, 2016

(54) Vehicle Side View Mirror with an Adjusting Device

(71) Applicant: Hsin-Chien Tseng, Tainan City (TW)

(72) Inventor: Hsin-Chien Tseng, Tainan City (TW)

(21) Appl. No.: 14/621,433

(22) Filed: Feb. 13, 2015

(30) Foreign Application Priority Data
Jan. 30, 2015 (TW) 104201489

(51) Int. Cl. B60R 1/06

(52) U.S. Cl. CPC B60R 1/06

(57) ABSTRACT

A vehicle side view mirror includes a mirror housing receiving a base and a mirror unit. The base includes a first ball joint portion having a peg. A mirror seat is movably coupled to the base and includes a second ball joint portion. The mirror unit is mounted to the mirror seat. A convex face of the second ball joint portion abuts a concave face of the first ball joint portion. A pressing member is mounted in the mirror seat. A resilient member includes at least one pressing end pressing against the pressing member. A mounting member extends through the resilient member. The mounting member is in threading connection with the peg. The at least one pressing end of the resilient member biases the pressing member towards the base. The second ball joint portion is held between the pressing member and the first ball joint portion.

### BACKGROUND OF THE INVENTION

The present invention relates to a vehicle side view mirror and, more particularly, to a vehicle side view mirror with an adjusting device permitting easy assemblage and providing adjustable uniform frictional resistance.

A side view mirror is mounted to each of left and right sides of a vehicle, such that the driver can observe the road conditions behind the driver to avoid collision while the driver intends to change the lane or take a turn. A conventional side view mirror generally includes an adjusting device capable of adjusting an angular position of a mirror to a desired location to enable the driver to clearly observe the road conditions behind the vehicle. A conventional adjusting device includes a fixed seat and a movable sleeve pivotably mounted around the fixed seat. A long groove is formed in a bottom of the fixed seat and extends in a radial direction. An intermediate portion of the long groove includes an axially extending through-hole and an engagement plate having a transverse hole. The engagement plate can extend into the through-hole to align the transverse hole with the long groove. The movable sleeve is pivotably mounted to the fixed seat. Two pins on two ends of an elongated bridging member are pivotably received in pivotal grooves in opposite sidewalls of the movable sleeve. An elongated resilient plate extends through the long groove and the transverse hole of the engagement plate. A distal end of the engagement plate is engaged in an intermediate portion of the bridging member. The adjusting device is, thus, formed. The fixed seat can be fixed in the mirror housing of the side view mirror. Then, the mirror unit is mounted to the surface of the movable sleeve, accomplishing assemblage of the side view mirror.

During the assemblage of the adjusting device, a tool is required to change the movable sleeve into an elliptic shape, such that an enlarged opening extending along the longitudinal axis of the elliptic shape is formed between the pivotal grooves at the opposite sidewalls of the movable sleeve so as to permit the pins at two ends of the bridging member to move into the pivotal grooves. The tool is then loosened, and the movable sleeve restores its spherical shape, such that the bridging member can be pivotably mounted in the movable sleeve. The assemblage is troublesome and time-consuming, because the tool is required to form the enlarged opening in the movable sleeve for pivotal connection of the bridging member. Furthermore, after the elongated resilient plate extends through the long groove and bends, the returning force of the resilient plate presses against the engagement plate to retain the bridging member in place, and the pins on the two ends of the bridging member press against the pivotal grooves by the pivotal sections of the pins. Thus, the pressing force concentrates in the pivotal grooves, such that the frictional resistance distribution between the movable sleeve and the fixed seat is not uniform. As a result, a user cannot obtain an appropriate angular position of the side view mirror through manual adjustment. Furthermore, after the elongated resilient plate has been installed, the pressing forces of the pins on two ends of the bridging member acting on the pressing grooves are fixed, such that adjustment of the frictional resistance between the movable sleeve and the fixed seat is impossible.

Thus, a need exists for a novel vehicle side view mirror permitting easy assemblage and providing adjustable uniform frictional resistance.

### BRIEF SUMMARY OF THE INVENTION

The present invention solves this need and other problems in the field of assemblage and adjustment of vehicle side view mirrors by providing a vehicle side view mirror including a mirror housing having a receiving space. A base is fixed in the receiving space of the mirror housing. The base includes a first surface and a second surface spaced from the first surface along a longitudinal axis. The base further includes a first ball joint portion defined in the first surface. The first ball joint portion includes a concave face and a peg extending from the concave face along the longitudinal axis. A mirror seat is movably coupled to the base. The mirror seat includes a first face and a second face spaced from the first face along the longitudinal axis. The mirror seat further includes a second ball joint portion protruding from the second face. The second ball joint portion includes a convex face. The second ball joint portion defines a socket in the first face and a through-hole extending from a bottom wall of the socket through the convex face of the second ball joint portion. The second ball joint portion is received in the first ball joint portion. The peg extends through the through-hole of the second ball joint portion and is received in the socket. The convex face of the second ball joint portion abuts the concave face of the first ball joint portion. A pressing member is mounted in the socket of the mirror seat. The pressing member includes a convex face and an end face. The pressing member further includes a through-hole extending from the end face through the convex face of the pressing member. The peg of the base extends through the through-hole of the pressing member. A resilient member includes at least one pressing end pressing against the end face of the pressing member. A mounting member extends through the resilient member and is in threading connection with the peg. The at least one pressing end of the resilient member biases the pressing member towards the base. The second ball joint portion of the mirror seat is held between the pressing member and the first ball joint portion. A mirror unit is mounted to the first face of the mirror seat.

The resilient member can be a plate having a root in a center thereof and can include a plurality of legs extending radially outwards from the root. The at least one pressing end includes a plurality of pressing ends. Each of the plurality of legs includes a distal end forming one of the plurality of pressing ends. The plurality of legs has an identical elastic coefficient and is spaced from each other at regular angular intervals, providing uniform frictional resistance between the concave face of the first ball joint portion and the convex face of the second ball joint portion.

The pressing member can further include a recessed portion in the end face. The recessed portion extends towards but is spaced from the convex face of the pressing member. The through-hole of the pressing member is located in the recessed portion. The peg is received in the recessed portion. The at least one pressing end of the resilient member contacts an inner face of the recessed portion.

The concave face of the first ball joint portion and the convex face of the second ball joint portion can have an identical curvature.

The mounting member can be a screw. When the screw is rotated in a tightening direction to press the resilient member against the peg, the resilient member exerts a first pressing force on the pressing member. A first frictional resistance exists between the concave face of the first ball joint portion and the convex face of the second ball joint portion. When the screw is rotated in a loosening direction to provide a first spacing between the resilient member and the peg, the resilient member exerts a second pressing force on the pressing member. A second frictional resistance exists between the concave face of the first ball joint portion and the convex face of the second ball joint portion. The second pressing force is smaller than the first pressing force, and the second frictional resistance is smaller than the first frictional resistance.

When the screw is rotated to provide a second spacing between the resilient member and the peg larger than the first spacing, the resilient member exerts a third pressing force on the pressing member, and a third frictional resistance exists between the concave face of the first ball joint portion and the convex face of the second ball joint portion. The third pressing force is smaller than the second pressing force, and the third frictional resistance is smaller than the second frictional resistance.

The base can further include two positioning rods extending outward from the first surface. The mirror seat further includes two slots extending from an inner wall face of the socket through the convex face of the second ball joint portion. Each of the two positioning rods is received in one of the two slots to prevent the mirror seat from pivoting relative to the base about the peg.

The present invention will become clearer in light of the following detailed description of illustrative embodiments of this invention described in connection with the drawings.

### DESCRIPTION OF THE DRAWINGS

FIG. 1 is an exploded, perspective view of a vehicle side view mirror according to the present invention.

FIG. 2 is an exploded, perspective view of an adjusting device of the vehicle side view mirror of FIG. 1.

FIG. 3 is a perspective view of the vehicle side view mirror of FIG. 1 after assembly.

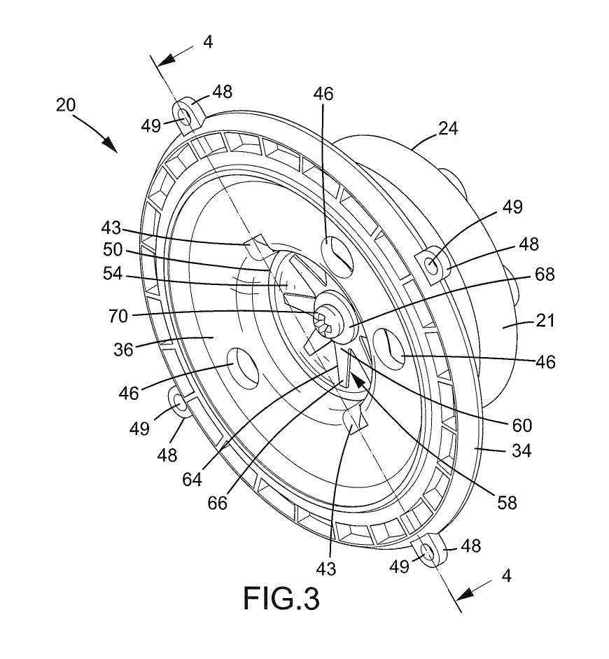

FIG. 4 is a cross sectional view taken along section line 4-4 of FIG. 3.

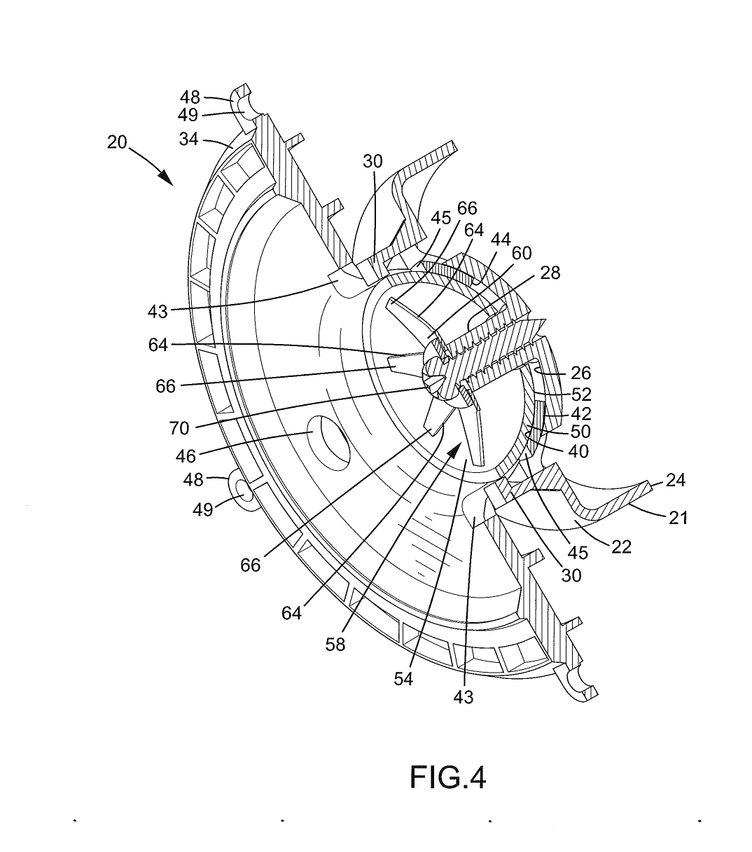

FIG. 5 is a perspective view of the vehicle side view mirror of FIG. 1 mounted to a side of a vehicle.

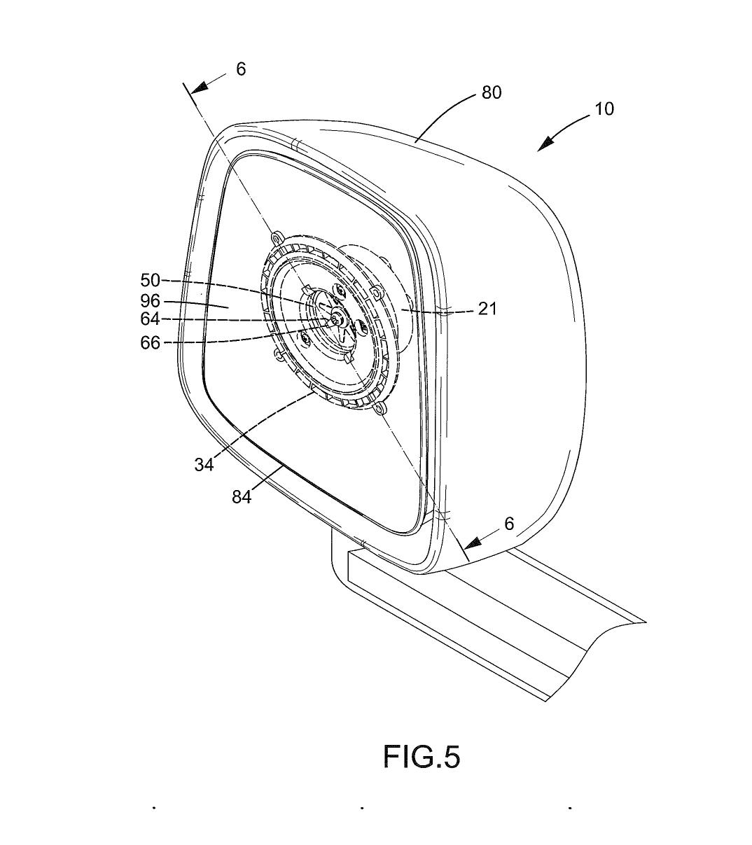

FIG. 6 is a cross sectional view taken along section line 6-6 of FIG. 5.

FIG. 7 is a view similar to FIG. 6, with a mirror moved to an inclined position.

FIG. 8 is a view similar to FIG. 6, with a mounting member loosened.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “third”, “inner”, “outer”, “bottom”, “side”, “end”, “portion”, “longitudinal”, “spacing”, and similar terms are used herein, it should be understood that these terms have reference only to the structure shown in the drawings as it would appear to a person viewing the drawings and are utilized only to facilitate describing the illustrative embodiments.

### DETAILED DESCRIPTION OF THE INVENTION

A vehicle side view mirror 10 according to the present invention is mounted to a left or right side of a vehicle and can be manually adjusted to an appropriate angular position to enable a driver to clearly observe the road conditions behind the left or right side of the vehicle. The vehicle side view mirror 10 includes a mirror housing 80 having a receiving space 81 in which a positioning board 82 is mounted.

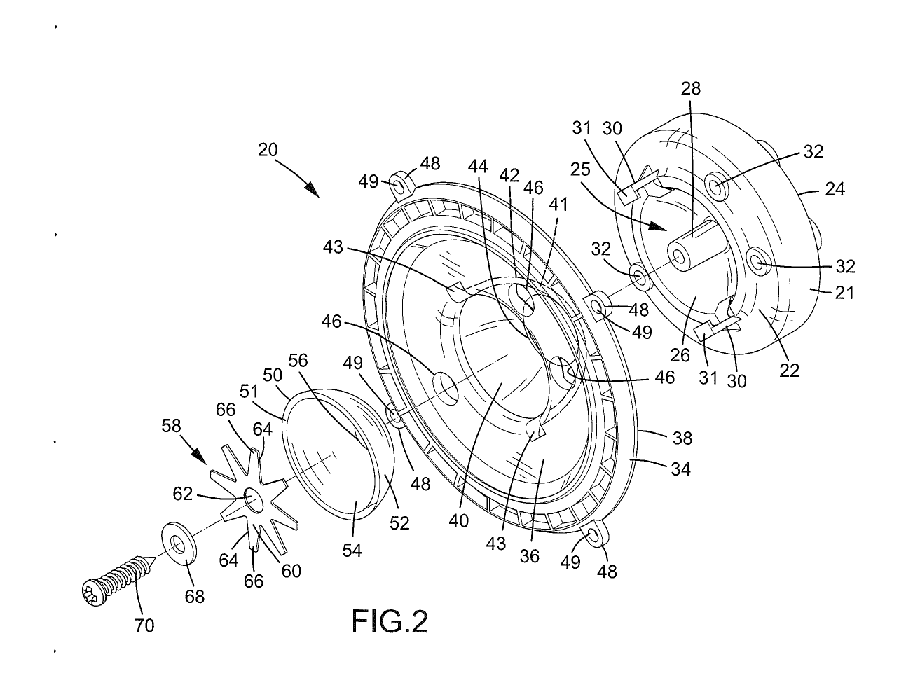

The vehicle side view mirror 10 includes an adjusting device 20 mounted to the positioning board 82 and located in the receiving space 81. The adjusting device 20 includes a base 21 having a first surface 22 and a second surface 24 spaced from the first surface 22 along a longitudinal axis. The base 21 further includes a first ball joint portion 25 defined in the first surface 22. The first ball joint portion 25 includes a concave face 26 and a peg 28 extending from the concave face 26 along the longitudinal axis. The base 21 further includes a plurality of through-holes 32 extending from the first surface 22 through the second surface 24. The base 21 further includes two positioning rods 30 formed on the first surface 22 and diametrically disposed on opposite sides of the peg 28. Each positioning rod 30 has a distal end 31 (FIG. 2).

According to the form shown, adjusting device 20 further includes a mirror seat 34 movably coupled to the base 21. The mirror seat 34 includes a first face 36 and a second face 38 spaced from the first face 36 along the longitudinal axis. The mirror seat 34 further includes a second ball joint portion 41 protruding from the second face 38. The second ball joint portion 41 includes a convex face 42 having a curvature identical to a curvature of the concave face 26 of the first ball joint portion 25. The second ball joint portion 41 defines a socket 40 in the first face 36 and spaced from the convex face 42. A through-hole 44 extends from a bottom wall of the socket 40 through the convex face 42. The through-hole 44 has a diameter larger than an outer diameter of the peg 28. The mirror seat 34 further includes a plurality of holes 46 extending from the first face 36 through the second face 38. Each hole 46 is aligned with one of the through-holes 32 of the base 21. Four lugs 48 are formed on a periphery of the mirror seat 34 and are spaced from each other by regular angular intervals. Each lug 48 has a hole 49 extending along an axis parallel to and spaced from the longitudinal axis. The mirror seat 34 further includes two slots 43 spaced from each other and extending from an inner wall face of the socket 40 through the convex face 42 of the second ball joint portion 41.

The second ball joint portion 41 of the mirror seat 34 is received in the first ball joint portion 25. The convex face 42 abuts the concave face 26. Each of the two positioning rods 30 is received in one of the two slots 43. The peg 28 extends through the through-hole 44 and is received in the socket 40. Since the diameter of the through-hole 44 is larger than the outer diameter of the peg 28, the convex face 42 of mirror seat 34 can pivot while abutting the convex face 26 of the base 21. However, pivotal movement of the mirror seat 34 relative to the base 21 about the peg 28 is avoided by the arrangement of the positioning rods 30 received in the slots 43.

According to the form shown, adjusting device 20 further includes a pressing member 50 mounted in the socket 40 of the mirror seat 34. The pressing member 50 is substantially bowl-shaped and includes a convex face 52 and an end face 51. The pressing member 50 further includes a through-hole 56 extending from the end face 51 through the convex face 52 of the pressing member 50. The peg 28 of the base 21 extends through the through-hole 56 of the pressing member 50. In this embodiment, the pressing member 50 further includes a recessed portion 54 in the end face 51. The recessed portion 54 extends towards but is spaced from the convex face 52 of the pressing member 50. The through-hole 56 of the pressing member 50 is located in the recessed portion 54. The peg 28 is received in the recessed portion 54.

According to the form shown, adjusting device 20 further includes a resilient member 58 received in the recessed portion 54 of the pressing member 50. The resilient member 58 is a plate having a root 60 in a center thereof. The root 60 has a central hole 62. A plurality of legs 64 extends radially outwards from the root 60. Each leg 64 includes a distal end 66 forming a pressing end 66 spaced from the root 60. The legs 64 are identical in shape and in size. Furthermore, the legs 64 have an identical elastic coefficient and are spaced from each other at regular angular intervals. The pressing end 66 of each leg 64 presses against the inner face of the recessed portion 54.

According to the form shown, adjusting device 20 further includes a mounting member 70 in the form of a screw extending through a washer 68 and the resilient member 58 into a screw hole in an end face of the peg 28 of the base 21. Thus, the resilient member 58 is positioned between the washer 68 and the central hole 62 of the pressing member 50. Furthermore, the resilient member 58 is biased by the pressing ends 66 of the legs 64 towards the pressing member 50, such that the convex face 52 of the pressing member 50 cooperates the concave face 26 of the base 21 to hold the mirror seat 34, generating a frictional resistance for retaining the mirror seat 34 in place.

The adjusting device 20 is fixed to the positioning board 82 of the mirror housing 80 by extending screws 94 through the holes 46 of the mirror seat 34 and the through-holes 32 of the base 21. Thus, the adjusting device 20 is fixed in the receiving space 81 of the mirror housing 80.

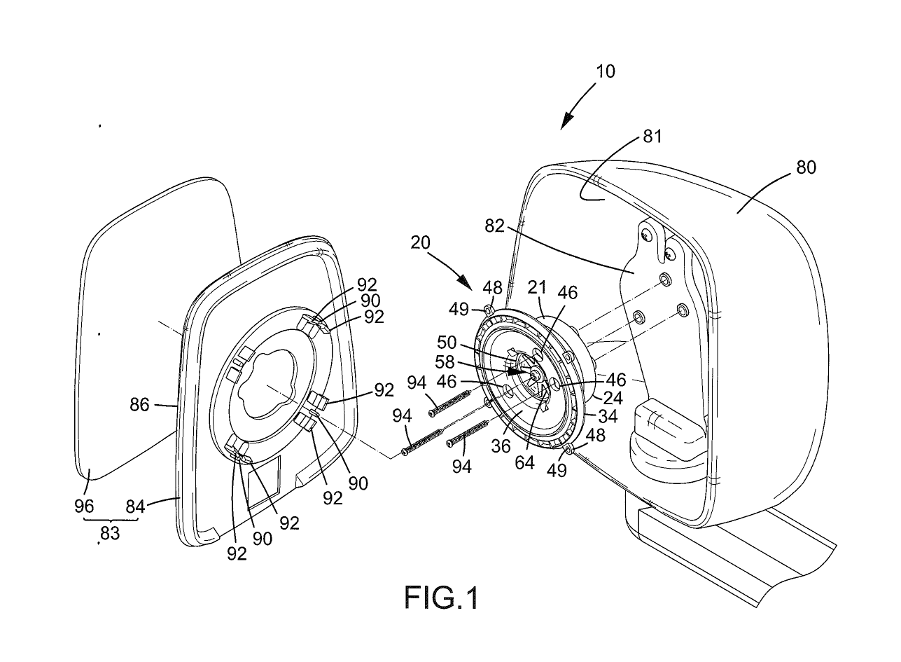

According to the form shown, the vehicle side view mirror 10 further includes a mirror unit 83. The mirror unit 83 includes a fixing board 84 and a mirror 96 mounted to the fixing board 84. The fixing board 84 includes a bonding face 86. Four protrusions 90 are formed on a rear face of the fixing board 84 opposite to the bonding face 86 and are spaced from each other at regular angular intervals. Two hooks 92 are provided on two sides of each protrusion 90 (FIG. 1). The mirror 96 is bonded to the bonding face 86 of the fixing board 84. Each protrusion 90 of the fixing board 84 is engaged in the hole 49 of one of the lugs 48. Each hook 92 is engaged with the second face 38 of the mirror seat 34. Thus, the mirror unit 83 and the mirror seat 34 are jointly moveable.

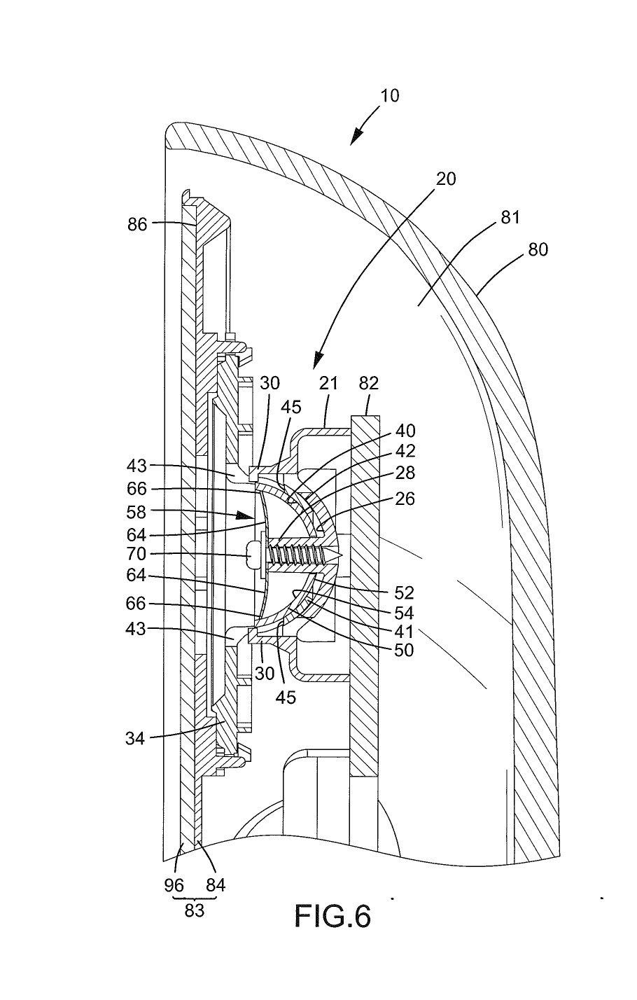

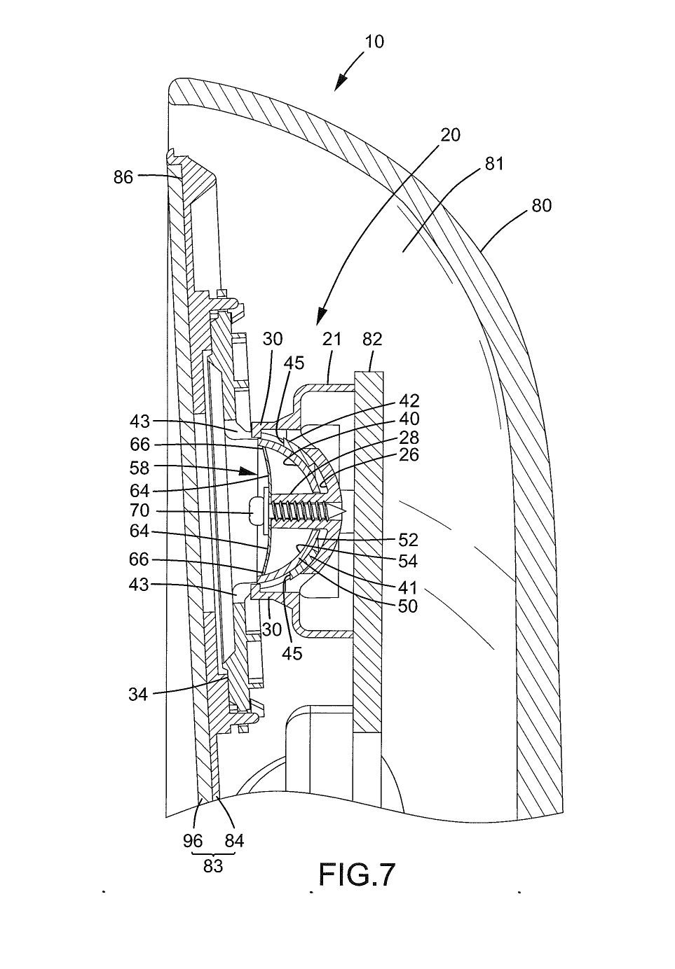

For the sake of explanation, it will be assumed that the mounting member 70 is tightened to make the root 60 of the resilient member 58 press against the end face of the peg 28 of the base 21 (FIG. 6). In this case, the pressing member 58 has larger elastic deformation, such that the force exerted by the pressing member 58 on the pressing member 50 is larger. Thus, the frictional resistance exerted on the second ball joint portion 41 of the mirror seat 34 is larger to provide a better positioning effect for the mirror seat 34 and the mirror unit 83. Note that the angular positions of the mirror seat 34 and the mirror unit 83 can still be adjusted (see FIG. 7), although the movement of the mirror seat 34 and the mirror unit 83 are not easy due to the large frictional resistance.

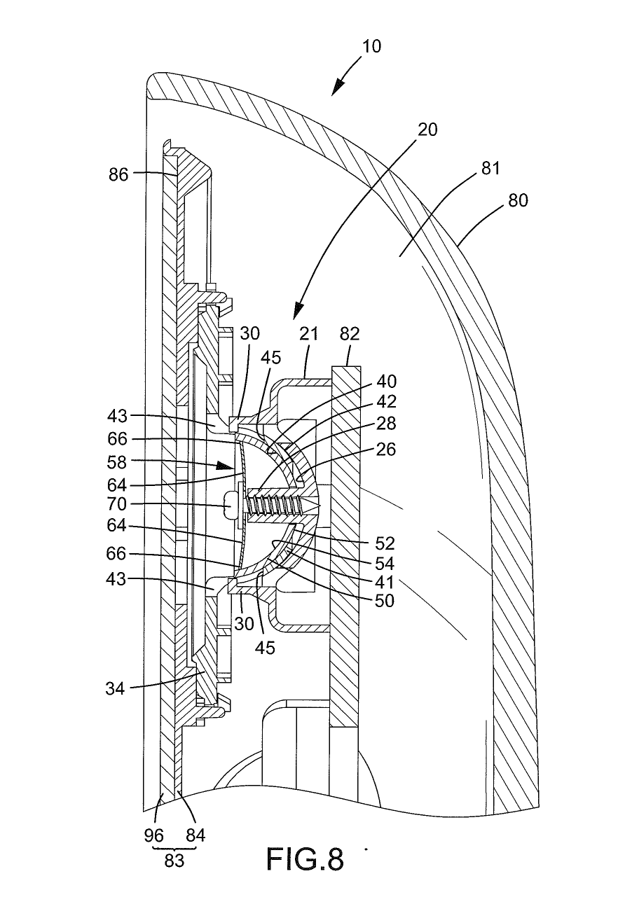

If the mounting member 70 is rotated in a loosening direction (but still presses against the resilient member 58) to a location in which the root 60 of the pressing member 58 is spaced from the end face of the peg 28 of the base 21 by a spacing (FIG. 8), the elastic deformation of the resilient member 58 is smaller, such that the force exerted by the resilient member 58 on the pressing member 50 is smaller than the case shown in FIG. 6. Thus, the frictional resistance exerted on the second ball joint portion 41 of the mirror seat 34 is smaller than the case shown in FIG. 6. However, the mirror seat 34 and the mirror unit 83 can still be positioned while permitting easier adjustment of the angular positions of the mirror seat 34 and the mirror unit 83 due to the smaller frictional resistance. Furthermore, the larger the spacing between the root 60 of the pressing member 58 and the end face of the peg 28, the smaller the force exerted by the resilient member 58 on the pressing member 50. Namely, the frictional resistance between the concave face 26 and the convex face 42 is smaller when the spacing is larger.

In assembly, the second ball joint portion 41 of the mirror seat 34 is received in the first ball joint portion 25 of the base 21. The mounting member 70 extends through the resilient member 58 and the pressing member 50 and is screwed into the peg 28, accomplishing assembly of the adjusting device 20. In comparison with the conventional technique requiring a tool to enlarge the movable sleeve, the adjusting device 20 according to the present invention can easily be assembled with less effort to increase the yield, which is suitable to mass production in the industry.

Since the legs 64 of the resilient member 58 are in a radiate arrangement, have the same shape and size, and are spaced from each other at regular angular intervals, the pressing force provided by the deformed resilient member 58 can uniformly exert on the mirror seat 34, such that a uniform forward pressing force can be created between the concave face 26 of the first ball joint portion 25 and the convex face 42 of the second ball joint portion 41. Thus, a uniform frictional resistance is created between the concave face 26 and the convex face 42. As a result, when the angular position of the mirror 96 is manually adjusted, the same frictional resistance is encountered regardless of the position of the mirror 96 is manually pushed. Thus, the user can manually adjust the mirror 96 to an appropriate position enabling the driver to clearly observe the road conditions behind the left or right side of the vehicle.

Due to the deformability of the legs 64 of the resilient member 58, the engagement tightness between the mounting member 70 and the peg 28 can be adjusted to adjust the deformation of the legs 64 of the resilient member 58, such that the forward abutting force between the convex face 42 and the concave face 26 can be adjusted, which, in turn, permits adjustment of the frictional resistance between the abutting portions of the mirror seat 34 and the base 21. Accordingly, the frictional resistance can be adjusted according to the actual products.

Now that the basic teachings of the present invention have been explained, many extensions and variations will be obvious to one having ordinary skill in the art. For example, the first surface 22 of the base 21 does not have to include the positioning rods 30 without causing limitation to movement of the first ball joint portion 25 and the second ball joint portion 41 in a curvature. Furthermore, instead of the end face 51 with a recessed portion 54, the end face 51 of the pressing member 50 can be plane, and the through-hole 56 directly extends from the plane end face 51 through the convex face 52 of the pressing member 50. In this case, the pressing ends 66 of the legs 64 of the resilient member 58 press against the plane end face 51.

Thus since the illustrative embodiments disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

1. A vehicle side view mirror comprising:
a mirror housing including a receiving space;
a base fixed in the receiving space of the mirror housing, with the base including a first surface and a second surface spaced from the first surface along a longitudinal axis, with the base further including a first ball joint portion defined in the first surface, and with the first ball joint portion including a concave face and a peg extending from the concave face along the longitudinal axis;
a mirror seat movably coupled to the base, with the mirror seat including a first face and a second face spaced from the first face along the longitudinal axis, with the mirror seat further including a second ball joint portion protruding from the second face, with the second ball joint portion including a convex face, with the second ball joint portion defining a socket in the first face and a through-hole extending from a bottom wall of the socket through the convex face of the second ball joint portion, with the second ball joint portion received in the first ball joint portion, with the peg extending through the through-hole of the second ball joint portion and received in the socket, and with the convex face of the second ball joint portion abutting the concave face of the first ball joint portion;
a pressing member mounted in the socket of the mirror seat, with the pressing member including a convex face and an end face, with the pressing member further including a through-hole extending from the end face through the convex face of the pressing member, with the peg of the base extending through the through-hole of the pressing member;
a resilient member including at least one pressing end pressing against the end face of the pressing member;
a mounting member extending through the resilient member, with the mounting member being in threading connection with the peg, with the at least one pressing end of the resilient member biasing the pressing member towards the base, and with the second ball joint portion of the mirror seat held between the pressing member and the first ball joint portion; and
a mirror unit mounted to the first face of the mirror seat.

2. The vehicle side view mirror as claimed in claim 1, with the resilient member being a plate having a root in a center thereof, with a plurality of legs extending radially outwards from the root, with the at least one pressing end including a plurality of pressing ends, with each of the plurality of legs including a distal end forming one of the plurality of pressing ends, with the plurality of legs having an identical elastic coefficient and spaced from each other at regular angular intervals, providing uniform frictional resistance between the concave face of the first ball joint portion and the convex face of the second ball joint portion.

3. The vehicle side view mirror as claimed in claim 1, with the pressing member further including a recessed portion in the end face, with the recessed portion extending towards but spaced from the convex face of the pressing member, with the through-hole of the pressing member located in the recessed portion, with the peg received in the recessed portion, and with the at least one pressing end of the resilient member contacting an inner face of the recessed portion.

4. The vehicle side view mirror as claimed in claim 1, wherein the concave face of the first ball joint portion and the convex face of the second ball joint portion have an identical curvature.

5. The vehicle side view mirror as claimed in claim 1, with the mounting member being a screw,
wherein when the screw is rotated in a tightening direction to press the resilient member against the peg, the resilient member exerts a first pressing force on the pressing member, and a first frictional resistance exists between the concave face of the first ball joint portion and the convex face of the second ball joint portion, and
wherein when the screw is rotated in a loosening direction to provide a first spacing between the resilient member and the peg, the resilient member exerts a second pressing force on the pressing member, a second frictional resistance exists between the concave face of the first ball joint portion and the convex face of the second ball joint portion, the second pressing force is smaller than the first pressing force, and the second frictional resistance is smaller than the first frictional resistance.

6. The vehicle side view mirror as claimed in claim 5, wherein when the screw is rotated to provide a second spacing between the resilient member and the peg larger than the first spacing, the resilient member exerts a third pressing force on the pressing member, a third frictional resistance exists between the concave face of the first ball joint portion and the convex face of the second ball joint portion, the third pressing force is smaller than the second pressing force, and the third frictional resistance is smaller than the second frictional resistance.

7. The vehicle side view mirror as claimed in claim 1, with the base further including two positioning rods extending outward from the first surface, with the mirror seat further including two slots extending from an inner wall face of the socket through the convex face of the second ball joint portion, and with each of the two positioning rods received in one of the two slots to prevent the mirror seat from pivoting relative to the base about the peg.
